(19) United States
(12) Patent Application Publication
(10) Pub. No.: US 2011/0139924 A1
(43) Pub. Date: Jun. 16, 2011

(54) TAIL BOOM

(76) Inventor: Shuichi Nakayama, Aichi (JP)

(21) Appl. No.: 12/595,884

(22) PCT Filed: Aug. 14, 2008
(86) PCT No.: PCT/JP2008/064579

§ 371 Date: Nov. 9, 2009

(30) Foreign Application Priority Data
Aug. 16, 2007 (JP) 2007-212197

(51) Int. Cl. B64C 27/82

(52) U.S. Cl. 244/17.21

(57) ABSTRACT

A tail boom capable of creating propulsive force during forward flight to increase the forward speed is provided. A tail boom producing a force that cancels out a torque effect due to the Coanda effect by forcing airflow generated by a propeller disposed on an upstream side downward through a slit penetrating in the thickness direction and provided at a lower part of one side surface is configured such that the airflow generated by the propeller contributes to the propulsive force during forward flight.

### TECHNICAL FIELD

The present invention relates to a tail boom disposed at the tail of a helicopter, for creating thrust.

### BACKGROUND ART

As a tail boom disposed at the tail of a helicopter, for creating thrust, one that generates anti-torque to the main rotor is known (for example, see Patent Document 1).
Patent Document 1: Japanese Unexamined Patent Application, Publication No. Hei 6-329096

### DISCLOSURE OF INVENTION

However, the tail boom disclosed in Patent Document 1 does not create thrust contributing to the propulsive force but generates only anti-torque to the main rotor.

The present invention has been made in view of the above-described circumstances, and an object thereof is to provide a tail boom that can generate propulsive force during forward flight to increase the forward speed.

To solve the above-described problem, the present invention employs the following solutions.

A tail boom according to a first aspect of the present invention is a tail boom producing a force that cancels out a torque effect due to the Coanda effect by forcing airflow generated by a propeller disposed on an upstream side downward through a slit penetrating in the thickness direction, provided at a lower part of one side surface, the tail boom being configured such that the airflow generated by the propeller contributes to propulsive force during forward flight.

In the tail boom according to the first aspect of the present invention, for example, during hovering, the airflow generated by the rotation of the propeller is forced downward through the slit provided at a lower part of one side surface of the tail boom. At this time, if the downwash of the main rotor system exists (acts) on both side surfaces of the tail boom, the downwash of the main rotor system flowing downward along the one side surface of the tail boom is accelerated, creating a force that cancels out the torque effect due to the Coanda effect on the side of the tail boom with the slit.

Furthermore, during forward flight, at least part of the airflow generated by the rotation of the propeller is directly guided backwards without passing through the slit, and this airflow contributes to (is used as) the propulsive force.

A tail boom according to a second aspect of the present invention is a tail boom producing a force that cancels out a torque effect due to the Coanda effect by forcing airflow generated by a propeller disposed on an upstream side downward through a slit penetrating in the thickness direction, provided at a lower part of one side surface, the tail boom including an airflow-path changing part for guiding almost all the airflow generated by the propeller to the slit during hovering and for guiding at least part of the airflow generated by the propeller directly backwards without allowing it to pass through the slit during forward flight.

In the tail boom according to the second aspect of the present invention, for example, during hovering, almost all the airflow generated by the rotation of the propeller is guided to the slit provided at a lower part of one side surface of the tail boom by the airflow-path changing part and is then forced downward through the slit. At this time, if the downwash of the main rotor system acts (exists) on both side surfaces of the tail boom, the downwash of the main rotor system flowing downward along the one side surface of the tail boom is accelerated, creating a force that cancels out the torque effect due to the Coanda effect on the side of the tail boom with the slit.

Furthermore, during forward flight, at least part of the airflow generated by the rotation of the propeller is directly guided backwards without passing through the slit by the airflow-path changing part, and this airflow contributes to (is used as) the propulsive force.

That is, the tail boom of the present invention can create a force that cancels out the torque effect (anti-torque) during, for example, hovering, and can create (auxiliary) thrust contributing to the propulsive force during forward flight.

A helicopter according to a third aspect of the present invention includes a tail boom that can create a force that cancels out a torque effect (anti-torque) during, for example, hovering, and can create (auxiliary) thrust contributing to the propulsive force during forward flight.

In the helicopter according to the third aspect of the present invention, the airflow generated by the propeller is mainly used to cancel out the torque effect of the main rotor during hovering, and is mainly used to obtain the propulsive force during forward flight.

Because the airflow generated by the propeller (thrust) can be contributed to (used as) the propulsive force during forward flight, the forward speed of the helicopter can be increased, achieving high-speed flight of the helicopter.

The tail rotor of the present invention has an advantage in that it can create the propulsive force during forward flight to increase the forward speed.

### BRIEF DESCRIPTION OF DRAWINGS

FIG. 1 is a schematic left-side sectional view of a helicopter including a tail boom according to an embodiment of the present invention, showing a state in which a door is open.

FIG. 2 is a sectional view taken along line II-II in FIG. 1.

FIG. 3 is a schematic left-side sectional view of a helicopter including a tail boom according to an embodiment of the present invention, showing a state in which a door is closed.

### BEST MODE FOR CARRYING OUT THE INVENTION

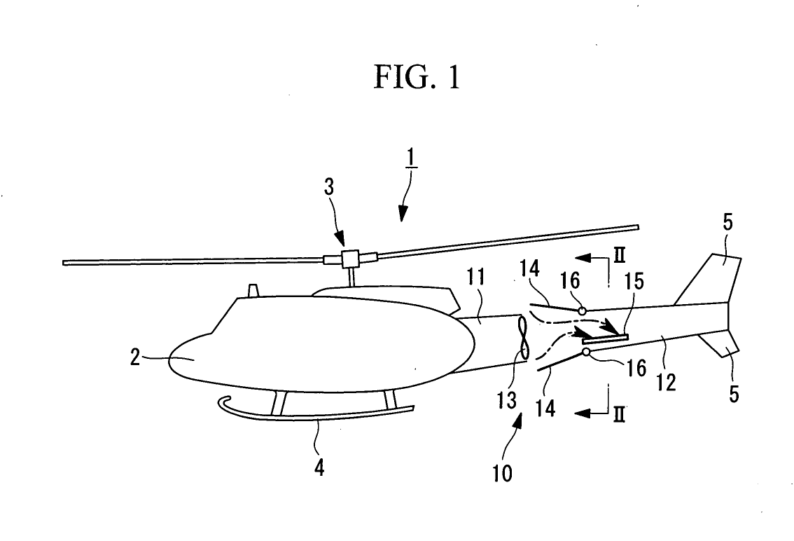

Referring to FIGS. 1 to 3, a tail boom (tail boom) according to an embodiment of the present invention will be described below.

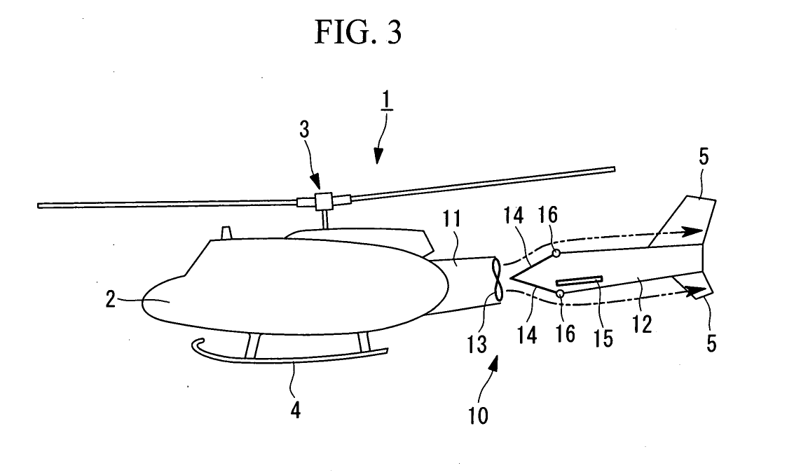

FIGS. 1 and 3 are schematic left-side sectional views of a helicopter (also referred to as a “rotary-wing aircraft”) 1 including a tail boom 10 according to this embodiment.

As shown in FIGS. 1 and 3, the main components constituting the helicopter 1 include a body 2, a main rotor system 3 disposed above the body 2, a landing gear 4 disposed below the body 2, the tail boom 10 disposed behind the body 2, and a vertical tail 5 disposed at the rearmost portion of the tail boom 10.

The tail boom 10 according to this embodiment includes a supporting portion (front end portion: base end portion) 11 and a supported portion (rear end portion) 12.

The forwardmost portion of the supporting portion 11 is attached (fixed) to the rearmost portion (rear end portion) of the body 2, and the rearmost portion of the supporting portion 11 has a propeller (fan) 13 attached thereto. The propeller 13 is rotated by a rotary force from a motor (for example, a gas turbine engine or the like) (not shown) transmitted through a main gear box (not shown) and a driveshaft (driveshaft). The rotation of the propeller 13 forces the ambient air (for example, the air introduced into the supporting portion 11 through an air intake (not shown) provided in the outer surface (outer circumferential surface) of the supporting portion 11) backwards, that is, toward the supported portion 12 of the tail boom 10 (see arrows with one-dot chain lines in FIG. 1 and arrows with two-dot chain lines in FIG. 3).

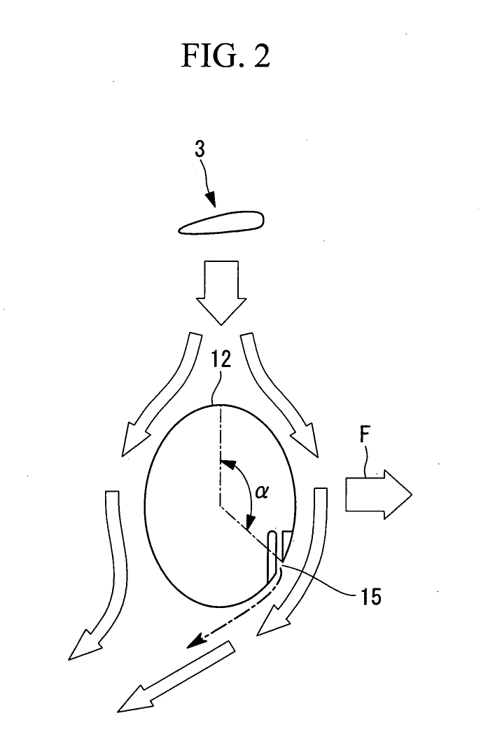

The supported portion 12 is a tubular member having, for example, an oval sectional shape, as shown in FIG. 2, whose front end is an open end and whose rear end is a closed end, and is attached (fixed) to the supporting portion 11 via a mount (supporting member) (not shown). Furthermore, the forwardmost portion of the supported portion 12 has a door (an opening/closing member: airflow-path changing part) 14 for opening and closing the open end formed at the front end, and the rearmost portion of the supported portion 12 has, attached (fixed) thereto, a vertical tail 5, which extends in the Z-axis (yaw axis: vertical axis) direction of the helicopter 1. In addition, a slit (air jetting port) 15 extending along the X-axis (roll axis) of the helicopter 1 and penetrating in the thickness direction is provided (formed) behind the door 14, at a lower part of the one side surface (right side surface in FIG. 2) of the supported portion 12 subjected to the influence of the downwash (downwash) of the main rotor system 3. As shown in FIG. 2, this slit 15 is provided at a position shifted from the top of the supported portion 12 downward along the one side surface of the supported portion 12 by angle α (from 70 to 160 degrees, most preferably, 140 degrees).

Note that a driving unit (for example, an electric motor) (not shown) for opening and closing the door 14 is attached to a hinge 16 connecting (joining) the rear end portion of the door 14 and the front end portion of the supported portion 12, and is configured (or is programmed in advance) to, for example, fully open the door 14 during hovering, as shown in FIG. 1, and fully close the door 14 during forward flight, as shown in FIG. 3.

As shown in FIGS. 1 and 2, when the door 14 is open (for example, during hovering), the air urged (forced) into the supported portion 12 by the propeller 13 is jetted downward through the slit 15 (see an arrow with one-dot chain line in FIG. 2). At this time, the downwash of the main rotor system 3 is divided above the supported portion 12, as shown by open arrows in FIG. 2, flows along both side surfaces of the supported portion 12, and is merged again below the supported portion 12. Because the flow rate of the (laminar) air jetted from the slit 15 is greater than the flow rate of the downwash flowing along the side surfaces of the supported portion 12, the downwash of the main rotor system 3 flowing downward along the one side surface of the supported portion 12 is accelerated, creating a force F that cancels out a torque effect (the effect that tends to rotate the helicopter in a direction opposite to the rotation direction of the main rotor system 3) (anti-torque) due to the Coanda effect on the side of the tail boom 10 with the slit 15.

On the other hand, as shown in FIG. 3, when the door 14 is closed (for example, during forward flight), the airflow forced toward the supported portion 12 by the propeller 13 flows backwards along the outer surface of the door 14 and the outer surface (outer circumferential surface) of the supported portion 12, and contributes to (is used as) the propulsive force during forward flight.

In the tail boom 10 according to this embodiment, when the door 14 is open, the airflow generated by the rotation of the propeller 13 is urged into the supported portion 12 and is jetted downward through the slit 15 provided at a lower part of one side surface of the supported portion 12. At this time, if the downwash of the main rotor system 3 acts (exists) on both side surfaces of the supported portion 12, the downwash of the main rotor system 3 flowing downward along the one side surface of the supported portion 12 is accelerated, creating the force F that cancels out the torque effect due to the Coanda effect on the side of the tail boom 10 with the slit 15.

On the other hand, when the door 14 is closed, the airflow generated by the rotation of the propeller 13 flows backwards along the outer surface of the door 14 and the outer surface (outer circumferential surface) of the supported portion 12, and contributes to (is used as) the propulsive force during forward flight.

That is, the tail boom 10 according to this embodiment can create the force F that cancels out the torque effect during, for example, hovering, and can create (auxiliary) thrust contributing to the propulsive force during forward flight.

Because the tail boom 10 is attached to the rearmost portion of the body 2 and the propeller 13 is rotated by the rotary force from the motor (for example, a gas turbine engine or the like) (not shown) transmitted through the main gear box (not shown) and the driveshaft to the propeller 13, it is possible to remove the tail boom from the existing helicopter and replace it with the tail boom 10.

Furthermore, in the tail boom 10 of this embodiment, because the vertical tail 5 is attached to the rearmost portion of the supported portion 12, the anti-torque during forward flight is cancelled out by the force created by the vertical tail, making it possible to contribute all the airflow (thrust) generated by the propeller 13 to the propulsive force. This further increases the forward speed of the helicopter 1, achieving a further increase in flight speed of the helicopter 1.

With the helicopter 1 having the tail boom 10 according to this embodiment, because the airflow (thrust) generated by the propeller 13 can be contributed to (used as) the propulsive force during forward flight, the forward speed of the helicopter 1 can be increased, achieving high-speed flight of the helicopter 1.

Moreover, because the propeller 13 is rotated by the rotary force from the motor (for example, a gas turbine engine or the like) (not shown) transmitted through the main gear box (not shown) and the driveshaft to the propeller 13, there is no need to prepare (provide) a separate driving unit for driving the propeller 13. Thus, it is possible to restrict (prevent) an increase in production costs and an increase in weight of the helicopter 1.

The present invention is not limited to the above-described embodiment, and it may be appropriately modified for implementation as needed. For example, it is also possible that both the front and rear ends of the supported portion 12 are formed as open ends and the rearmost portion of the supported portion 12 is provided with the door (the opening/closing member: airflow-path changing part) 14 for opening and closing the open end formed at the rear end.

Furthermore, it is more preferable that the air intake (air intake) for guiding the ambient air toward the upstream side of the propeller 13 extend outward further than the outside plate and open to the front.

This urges the air flowing along the airframe during forward flight from the air intake toward the propeller 13, forcing more air backwards by the propeller 13. Thus, larger airflow (thrust) can be generated.

1. A tail boom producing a force that cancels out a torque effect due to the Coanda effect by forcing airflow generated by a propeller disposed on an upstream side downward through a slit penetrating in the thickness direction, provided at a lower part of one side surface,
wherein the tail boom is configured such that the airflow generated by the propeller contributes to propulsive force during forward flight.

2. A tail boom producing a force that cancels out a torque effect due to the Coanda effect by forcing airflow generated by a propeller disposed on an upstream side downward through a slit penetrating in the thickness direction, provided at a lower part of one side surface, the tail boom comprising
an airflow-path changing part for guiding almost all the airflow generated by the propeller to the slit during hovering and for guiding at least part of the airflow generated by the propeller directly backwards without allowing it to pass through the slit during forward flight.

3. A helicopter comprising the tail boom according to claim 1.

4. A helicopter comprising the tail boom according to claim 2.
